(19) United States
(12) Patent Application Publication
(10) Pub. No.: US 2012/0288683 A1
(43) Pub. Date: Nov. 15, 2012

(54) PROTUBERANT STRUCTURE AND METHOD FOR MAKING THE SAME

(76) Inventors: Chin-Te Kuo, New Taipei City (TW); Yi-Nan Chen, Taipei City (TW); Hsien-Wen Liu, Taoyuan County (TW)

(21) Appl. No.: 13/104,943

(22) Filed: May 10, 2011

(51) Int. Cl. B32B 3/00; B05D 5/02

(52) U.S. Cl. 428/172; 427/271; 216/11

(57) ABSTRACT

The protuberant structure of the present invention includes a substrate and a protrusion disposed on the substrate. The protrusion has a top side, a bottom side and a tapered side wall disposed between the top side and the bottom side. The top side has an extremely small top width which is not greater than 32 nm.

### BACKGROUND OF THE INVENTION

1. Field of the Invention

The present invention generally relates to a protuberant structure and a method for forming a protuberant structure. In particular, the present invention is directed to a protuberant structure which has an extremely small dimension beyond the capability of the conventional photolithographic techniques on a substrate and a method for forming such protuberant structure.

2. Description of the Prior Art

During the process of fabricating silicon based memory chips, there are usually multiple photolithographic process steps involved. In each of these steps, a particular pattern with certain fixed dimensions is printed on the wafer. After all of the particular patterns are processed, a complete working circuit is accordingly created.

As a consequence of many factors, including the demands for portability, functionality, capacity and efficiency, integrated circuits are continuously being reduced in size, but the pattern features, such as conductive lines, are still usually formed by a photolithographic process. The concept of pitch is used to describe the sizes of these features. Pitch is defined as the distance between an identical point in two neighboring features of a repeating pattern. However, due to factors such as optical or physical phenomenon, conventional photolithographic techniques have a minimum size limitation beyond which a photolithographic technique fails to reliably form desirable features. Thus, the minimum pitch which a photolithographic technique can reliably define is an obstacle to the ongoing trend of feature size reduction.

It is known that a tapered cone profile can increase a process window. For example, a MOS gate in a cone shape or a tapered cone profile can result in a better interlayer dielectric fill or avoid shorts between contacts. However, the current process to form the tapered cone profile is not easy to produce a desired angle profile due to density or environmental reasons. Tapered cone profiles of different angles are not easy to produce, either.

### SUMMARY OF THE INVENTION

The present invention in a first aspect proposes a protuberant structure which has an extremely small dimension beyond the capability of the current photolithographic techniques on a substrate. The protuberant structure of the present invention includes a substrate and a protrusion disposed on the substrate. The protrusion has a top side, a bottom side and a tapered side wall disposed between the top side and the bottom side. The top side has an extremely small top dimension which is not greater than 32 nm.

In one embodiment of the present invention, the protrusion includes a metal, a semi-conductive material or an insulating material.

In another embodiment of the present invention, the protrusion is in a form of a wedge or a trapezoidal prism.

In another embodiment of the present invention, the protrusion is in a form of a cone or a truncated cone.

In another embodiment of the present invention, the protrusion is in a form of a pyramid.

In another embodiment of the present invention, the protrusion has a protuberant height at least 1 time greater than the top width.

In another embodiment of the present invention, the protrusion forms a sensor.

In another embodiment of the present invention, the protrusion forms a MEMS (micro-electromechanical structure).

The present invention in a second aspect proposes another protuberant structure which has an extremely small dimension beyond the capability of the current photolithographic techniques on a substrate. The protuberant structure of the present invention includes a substrate and a protrusion disposed on the substrate. The protrusion has a top side, a bottom side as well as a tapered side wall disposed between the top side and the bottom side. The area of the bottom side is at least 10 times greater than that of the top side.

In another embodiment of the present invention, the protrusion is in a form of a wedge or a trapezoidal prism.

In another embodiment of the present invention, the protrusion is in a form of a cone or a truncated cone.

In another embodiment of the present invention, the protrusion is in a form of a pyramid.

The present invention in a third aspect proposes a method for forming a protuberant structure which has an extremely small dimension beyond the capability of the current photolithographic techniques on a substrate. First, a substrate and a plurality of tapered structures disposed on the substrate are provided. The tapered structures include a first material, have a pre-determined bottom angle and are in a form of an inverse trapezoid. Second, a target layer of a second material is formed to cover the substrate and disposed between the tapered structures. The first material and the second material are different. Next, the tapered structures are completely removed. Later, a trimming step is carried out to partially remove the target layer to form a protrusion which is disposed on the substrate and has a top side, a bottom side and a tapered side wall disposed between the top side and the bottom side.

In one embodiment of the present invention, the top side has a top width not greater than 32 nm.

In one embodiment of the present invention, the area of the bottom side is at least 10 times greater than that of the top side.

In one embodiment of the present invention, the first material etching step is a high polymer etching step.

In one embodiment of the present invention, the protrusion includes a metal, a semi-conductive material or an insulating material.

In one embodiment of the present invention, the protrusion has a protuberant height at least 1 time greater than the protuberant width.

In one embodiment of the present invention, the method of the present invention further includes some additional steps. For example, a layer of the first material is formed on the substrate. Afterwards, the first material is partially removed by a first material etching step in the presence of a mask to form at least one recess which has an opening smaller than the bottom of the recess and is disposed between the tapered structures. The first material etching step may be a high polymer etching step to increase the polymer protection of the sidewall of the recess.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-7 illustrate the method for forming the protuberant structure of the present invention.

FIGS. 8-10 illustrate different embodiments of the protuberant structure of the present invention.

### DETAILED DESCRIPTION

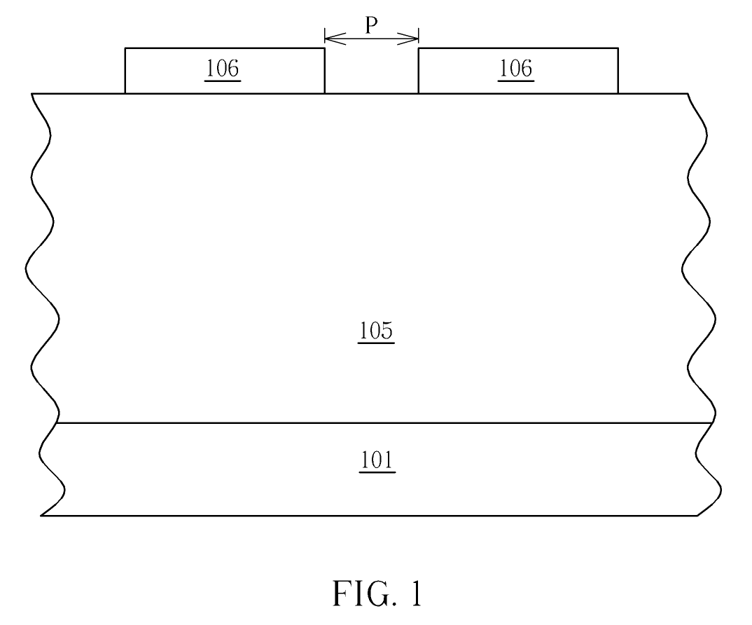

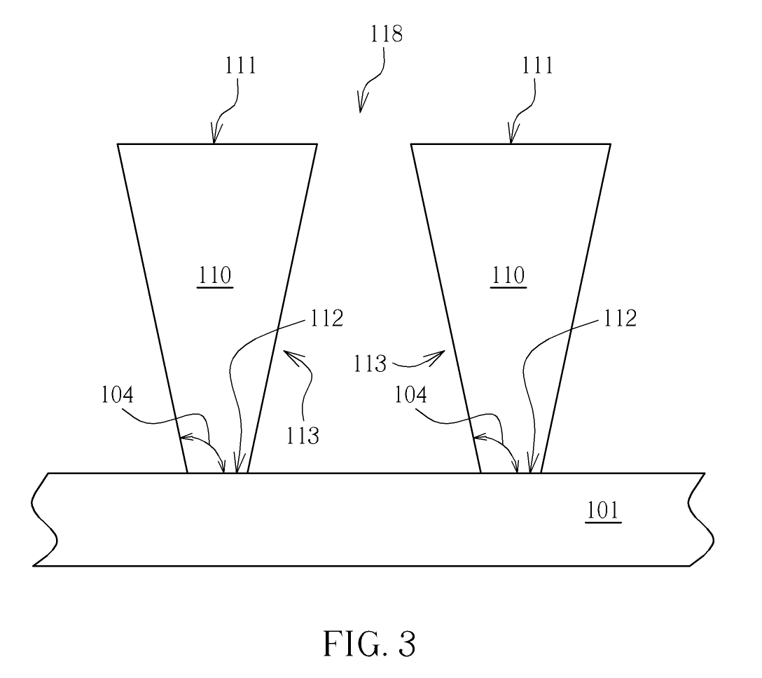

The present invention first provides a method for forming a protuberant structure. The protuberant structure in particular has an extremely small dimension which is not usually able to be formed by conventional photolithographic techniques. Please refer to FIGS. 1-7, which illustrate the method for forming the protuberant structure of the present invention. First, as shown in FIG. 3, a substrate 101 and a plurality of sacrificial structures 110 disposed on the substrate 101 are provided. The substrate 101 may be a semi-conductive material, such as Si, and the sacrificial structures 110 may include a first material such as an oxide. The sacrificial structures 110 each have cross sections which are in a form of an inverse trapezoid and have a top side 111, a bottom side 112 and a tapered side wall 113. The bottom side 112 which is smaller than the top side 111 in dimension is in direct contact with the substrate 101 and the tapered side wall 113 is disposed between the top side 111 and the bottom side 112. Since the sidewall 113 is tapered, the sidewall 113 of the sacrificial structures 110 adjustable to have a pre-determined bottom angle 114. For example, the pre-determined bottom angle 114 may be around 80 degrees. One feature of the present invention resides in that the top side 111 is substantially larger than the bottom side 112 in a certain dimension. For example, the width or the length is larger. The special shape of the sacrificial structures 110 of the present invention may be formed by the following procedures.

Please refer to FIG. 1, first a basic layer 115 is formed on and entirely covers the substrate 101. The basic layer 115 usually includes an oxide. Then, a patterned mask 116 is formed on the basic layer 115, such as by a conventional photolithographic method. Depending on the specifications of the final structure, the mask 116 may have different patterns. However, the pitch P of two adjacent mask regions of the mask 116 is preferably as small as possible.

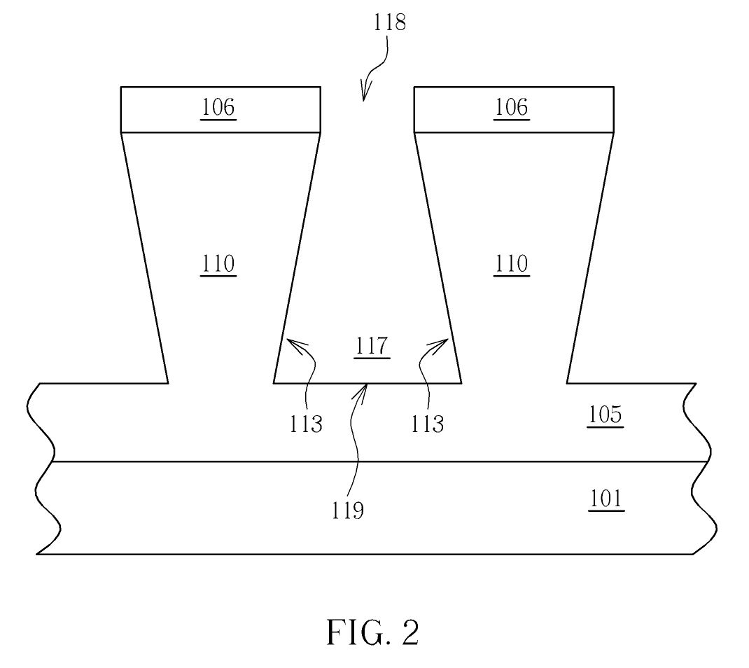

Second, please refer to FIG. 2, an enhanced etching step is carried out to partially remove the first material of the basic layer 115 and to partially expose the substrate 101. The recipe of the enhanced etching step is specially formulated, such as a high polymer etching step, to enhance the side-etching of the recess 117 of the basic layer 115 so that the recess 117 preferably has a bottom part 119 substantially larger than the opening 118. The conventional etching recipe usually forms a recess with a bottom part smaller than the opening. The recipe of the enhanced etching step may be a high polymer recipe.

After the enhanced etching step is complete, the patterned mask 116 is removed to obtain the sacrificial structures 110 in a form of an inverse trapezoid with a tapered side wall 113 of a desirable bottom angle 114, as shown in FIG. 3. The conditions and the recipes of the enhanced etching step may also be fine-tuned in order to obtain a different desirable bottom angle 114.

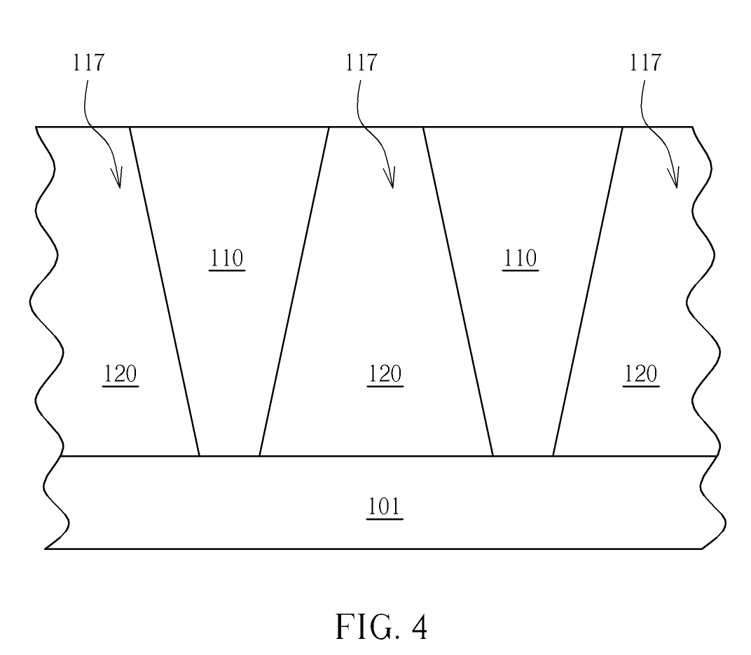

Second, as shown in FIG. 4, a target layer 120 of a second material is deposited to completely cover the exposed substrate 101 and to fill up the recess 117 disposed between the adjacent sacrificial structures 110. In other words, the previously formed sacrificial structures 110 act as containers to be the template of the target layer 120 or to reduce bridge or etch stop by a higher etch selectivity between containers and target materials, such as C₅F₈ or C₄F₈.

The first material and the second material are substantially different, or at least the first material and the second material must have good etching selectivity. For example, the second material may be a metal, a semi-conductive material or an insulating material other than the first material. In one embodiment, the second material may be poly Si if gate structures of extremely small dimension are needed. The excess second material on the sacrificial structures 110 may be removed in advance such as by etching or CMP.

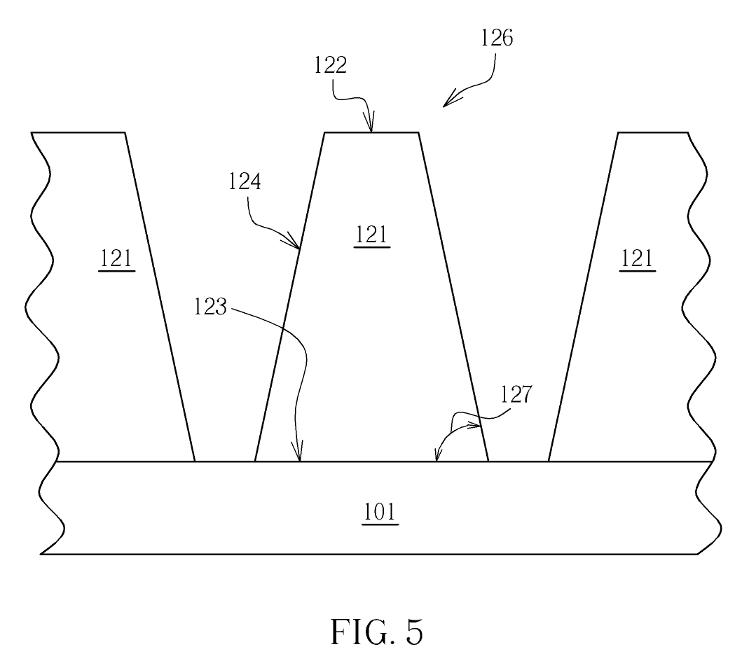

Next, as shown in FIG. 5, the sacrificial structures 110 are completely removed. For example, the sacrificial structures 110 are removed by a highly selective recipe so that the target layer 120 is not substantially damaged. For example, if the first material is an oxide and the second material is poly Si, the etching recipe may include C₄F₈ to substantially exclusively remove the oxide.

After the sacrificial structures 110 are completely removed, the target layer 120 forms multiple protrusions 121 disposed on the substrate 101 so a protuberant structure 126 is obtained. The present invention in a second aspect provides a protuberant structure 126 which has an extremely small dimension beyond the capability of current photolithographic techniques on a substrate 101.

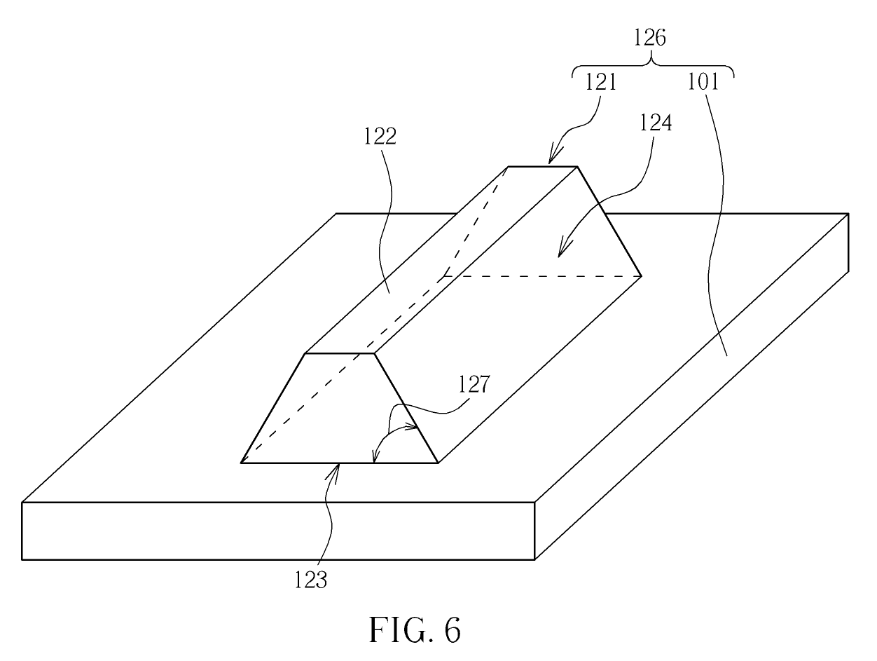

The protuberant structure 126 of the present invention includes a substrate 101 and a protrusion 121 disposed on the substrate 101. The protrusion 121 has a top side 122, a bottom side 123 and a tapered side wall 124 disposed between the top side 122 and the bottom side 123. One feature of the protrusion 121 is that the top side 122 is smaller than the bottom side 123 in at least one dimension, such as the width or the length. The tapered side wall 124 has a bottom angle 127 less than 90 degrees. The protrusion 121 may be in a form of trapezoidal prism of different sizes, as shown in FIG. 6.

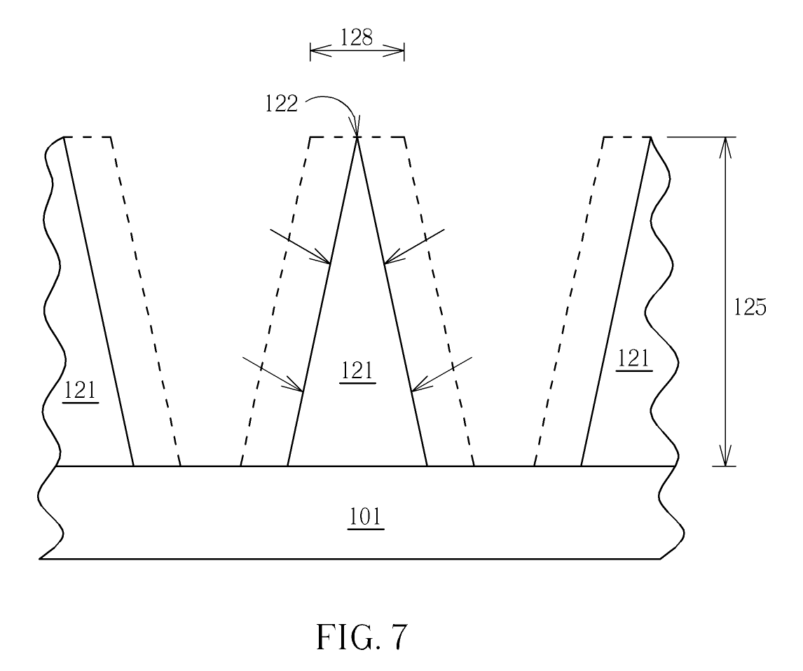

Optionally, as shown in FIG. 7, a trimming step may be carried out after the sacrificial structures 110 are completely removed. The trimming step is used to partially remove the target layer 120, now the protrusion 121, in particular to shrink the dimension of the top side 122 to change the shape of the protrusion 121. The trimming step may be a wet etching step to fine-tune the structure of protrusion 121 by adjusting an acid concentration. The trimming step may also increase the uniformity of the profile of the protrusion 121.

For example, if the size of the top side 122 is larger than 32 nm, the trimming step is able to reduce the size of the top side 122 so that size of the top side 122 becomes smaller than 32 nm to any desired degree. In other words, the top side 122 may have an extremely small top width which is not greater than 32 nm, or the top side 122 may even be trimmed further so that the top side 122 barely exists. In such a way, the area of the bottom side 123 is at least 10 times greater than that of the top side 122 or the protrusion 121 has a height 125 at least 1 time greater than the width 128 of the top side 122.

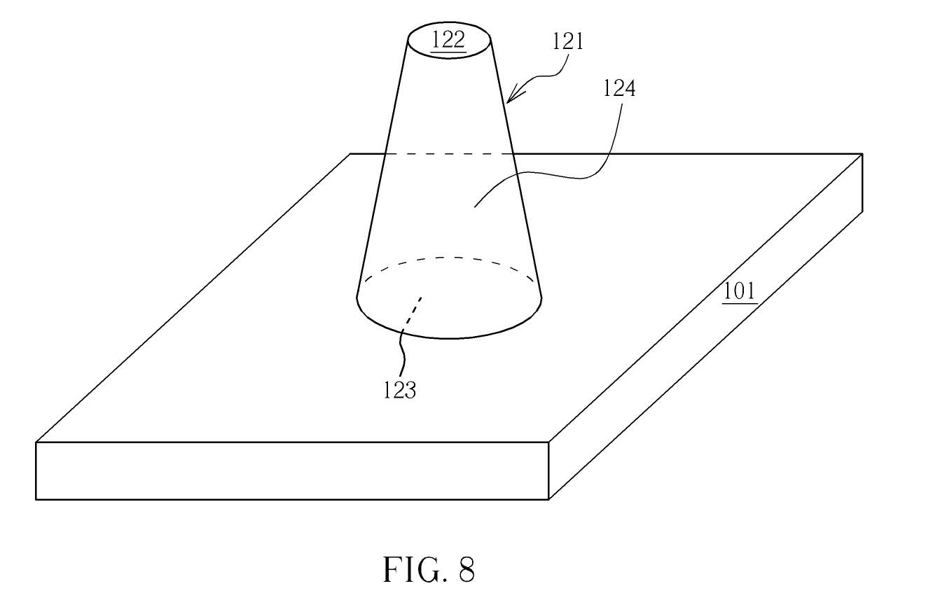

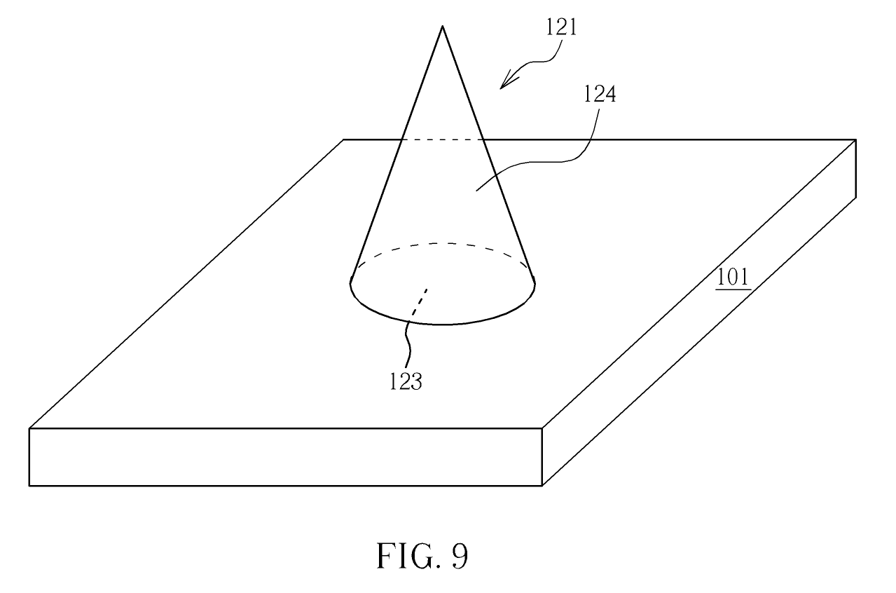

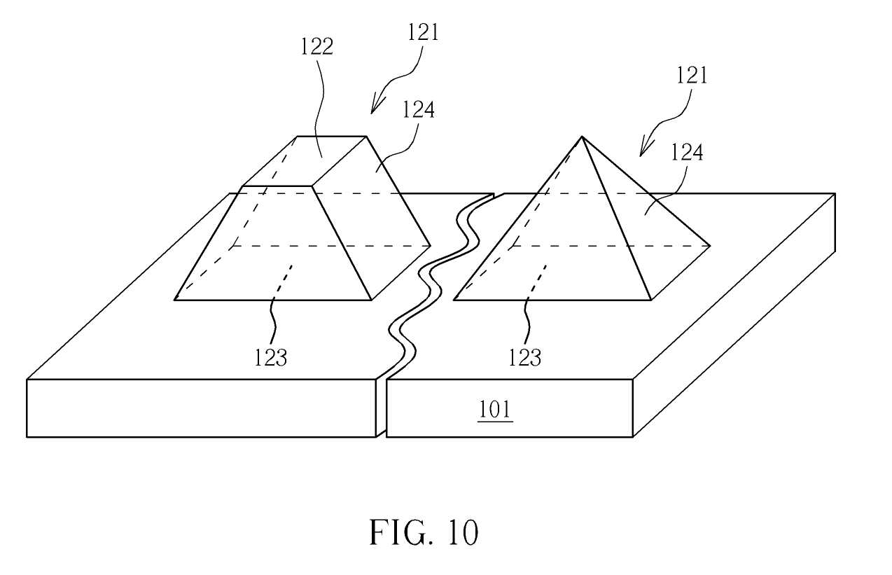

In accordance with different requirements of the protrusion 121, the protrusion 121 may be trimmed to form different shapes. For example, the protrusion 121 may be trimmed to form a wedge, as sown in FIG. 7. Or the protrusion 121 may be trimmed to form a truncated cone as shown in FIG. 8 or further to form a cone as shown in FIG. 9. Alternatively, the protrusion 121 may be trimmed to form a pyramid as shown in FIG. 10.

In one embodiment of the present invention, the protuberant structure 126 of the present invention may be a gate structure for use in a semiconductor structure. The size of the protuberant structure 126 of the present invention is too small to be formed by traditional photolithographic methods. A semiconductor device of a smaller size is critical in increasing the element density. The protuberant structure 126 of the present invention may also be used to form a sensor in a MEMS (microelectromechanical structure).

Those skilled in the art will readily observe that numerous modifications and alterations of the device and method may be made while retaining the teachings of the invention.

What is claimed is:

1. A protuberant structure, comprising:
a substrate; and
a protrusion disposed on said substrate and having a top side, a bottom side and a tapered side wall, wherein said top side has a top width not greater than 32 nm.

2. The protuberant structure of claim 1, wherein said substrate is a semi-conductive material.

3. The protuberant structure of claim 1, wherein said protrusion comprises a material selected from a group consisting of a metal, a semi-conductive material and an insulating material.

4. The protuberant structure of claim 1, wherein said protrusion is in a form of any one of a wedge and a trapezoidal prism.

5. The protuberant structure of claim 1, wherein said protrusion is in a form of any one of a cone and a truncated cone.

6. The protuberant structure of claim 1, wherein said protrusion is in a form of a pyramid.

7. The protuberant structure of claim 1, wherein said protrusion has a protuberant height at least 1 time greater than said top width.

8. The protuberant structure of claim 1, wherein said protrusion forms a sensor.

9. The protuberant structure of claim 1, wherein said protrusion forms a MEMS (microelectromechanical structure).

10. The protuberant structure of claim 1, further comprising:
a plurality of said protrusions disposed on said substrate.

11. A protuberant structure, comprising:
a substrate; and
a protrusion disposed on said substrate and having a top side, a bottom side and a tapered side wall, wherein the area of said bottom side is at least 10 times greater than that of said top side.

12. The protuberant structure of claim 11, wherein said protrusion is in a form of any one of a wedge and a trapezoidal prism.

13. The protuberant structure of claim 11, wherein said protrusion is in a form of any one of a cone and a truncated cone.

14. The protuberant structure of claim 11, wherein said protrusion is in a form of a pyramid.

15. A method for forming a protuberant structure, comprising:
providing a substrate and a plurality of tapered structures of a first material and of a pre-determined bottom angle disposed on said substrate, wherein said tapered structures are in a form of an inversed trapezoid;
forming a target layer of a second material to cover said substrate and to be disposed between said tapered structures, wherein said first material and said second material are different;
completely removing said tapered structures; and
performing a trimming step to partially remove said target layer to form a protrusion which is disposed on said substrate and has a tapered side wall, a top side and a bottom side.

16. The method for forming a protuberant structure of claim 15, wherein said top side has a top width not greater than 32 nm.

17. The method for forming a protuberant structure of claim 15, wherein the area of said bottom side is at least 10 times greater than that of said top side.

18. The method for forming a protuberant structure of claim 15, further comprising:
forming a layer of said first material on said substrate;
partially removing said first material by a first material etching step in the presence of a mask to form at least one recess which has an opening smaller than the bottom of said recess and is disposed between said tapered structures.

19. The method for forming a protuberant structure of claim 15, wherein said first material etching step is a high polymer etching step.

20. The method for forming a protuberant structure of claim 15, wherein said protrusion comprises a material selected from a group consisting of a metal, a semi-conductive material and an insulating material.

21. The method for forming a protuberant structure of claim 15, wherein said protrusion has a protuberant height at least 1 time greater than said protuberant width.
